(19) United States
(12) Patent Application Publication
(10) Pub. No.: US 2026/0307732 A1
(43) Pub. Date: Oct. 8, 2026

(54) REAR VEHICLE BODY STRUCTURE

(71) Applicants: Hyundai Motor Company, Seoul (KR); Kia Corporation, Seoul (KR)

(72) Inventors: Hae Hoon Lee, Hwaseong-si (KR); Dong Wook Kim, Hwaseong-si (KR); Hoyeon Kim, Hwaseong-si (KR)

(21) Appl. No.: 19/571,299

(22) Filed: Mar. 18, 2026

(30) Foreign Application Priority Data
Apr. 2, 2025 (KR) 10-2025-0042547
Aug. 19, 2025 (KR) 10-2025-0114719

(51) Int. Cl. B62D 25/08; B62D 25/04

(52) U.S. Cl. CPC B62D 25/08; B62D 25/04

(57) ABSTRACT

Embodiments provide a vehicle body structure. An embodiment of the vehicle body structure includes a rear pillar, a door hinge mounting bracket, and a door hinge reinforcement bulkhead. The rear pillar is configured to be arranged at a side of a rear of a vehicle body. The rear pillar includes a rear pillar inner member and a rear pillar outer member connectable to the rear pillar inner member to provide a closed cross-section between the rear pillar inner member and the rear pillar outer member. The door hinge mounting bracket is configured to be arranged within the closed cross-section of the rear pillar and connectable to the rear pillar outer member. The door hinge reinforcement bulkhead is configured to be arranged inside the closed cross-section of the rear pillar and connectable to the rear pillar inner member and the door hinge mounting bracket.

### CROSS-REFERENCE TO RELATED APPLICATIONS

This application claims priority to and the benefit of Korean Patent Application No. 10-2025-0042547 filed with the Korean Intellectual Property Office on Apr. 2, 2025, and Korean Patent Application No. 10-2025-0114719 filed with the Korean Intellectual Property Office on Aug. 19, 2025, the entire contents of which are incorporated herein by reference.

### TECHNICAL FIELD

Embodiments relate to a rear vehicle body structure.

### BACKGROUND

Recently, the vehicle industry has been introducing a new concept of future mobility vision for realizing a dynamic, human-centered future city. One of these future mobility solutions is a purpose-based mobility (Purpose Built Vehicle; PBV).

PBV is an example of an electric vehicle (EV)-based environment-friendly mobility vehicle. These PBVs can provide users with a variety of customized services during their travel from departure to destination.

PBV can be manufactured in various shapes and sizes depending on the user's use case. For example, PBV can be used as a hailing or delivery type (or cargo type) vehicle.

A twin swing door can be mounted on the rear of the PBV's vehicle body. Twin Swing doors can be rotatably mounted in a swinging manner through door hinges on both rear pillars located at the rear of the vehicle body.

The door hinge is mounted on the hinge mounting portions provided on the upper and lower sides of the rear pillars on both sides, and can be connected to each twin swing door.

The hinge mounting part may be provided with a hinge mounting bracket that is mounted at a predetermined position on both rear pillars. The hinge mounting bracket can be fitted inside the closed cross-section of both rear pillars.

The hinge mounting bracket can be mounted on both rear pillars to accommodate the assembly dispersion tendency of the twin swing door. That is, the position of the hinge mounting bracket can be adjusted to suit the assembly dispersion tendency of the twin swing door.

Since the hinge mounting brackets are independently mounted on the inside of both rear pillars, the twin swing door and both rear pillars by the hinge mounting brackets can be designed to provide mounting strength.

The information contained in this background section is intended to enhance understanding of the background of the invention and may include matters that are not conventional art already known to a person of ordinary skill in the field to which this technology belongs.

### SUMMARY

Embodiments provide a rear vehicle body structure that can enhance the mounting strength of a twin swing door while absorbing the assembly tolerances of the twin swing door.

A rear vehicle body structure according to an embodiment may include a rear pillar disposed at the rear of both sides of the vehicle body and including a rear pillar inner member and a rear pillar outer member connected to form a closed cross-section, a door hinge mounting bracket disposed within the closed cross-section of the rear pillar and connected to the rear pillar outer member, and a door hinge reinforcement bulkhead disposed inside the closed cross-section of the rear pillar and connected to the rear pillar inner member and the door hinge mounting bracket.

The rear vehicle body structure according to an embodiment may include a hinge reinforcement bracket connected to the rear pillar outer member and to which the door hinge mounting bracket is mounted.

The door hinge reinforcement bulkhead may be disposed in the same phase as the door hinge mounting bracket.

The door hinge mounting bracket and the door hinge reinforcement bulkhead, which are connected to each other, may be disposed in predetermined door hinge mounting sections at the upper and lower portions of the rear pillar.

The door hinge mounting bracket and the door hinge reinforcement bulkhead may be mounted at predetermined positions on the rear pillar inner member and the rear pillar outer member, respectively, and may be connected by the rear pillar inner member and the rear pillar outer member.

The door hinge mounting bracket may include a bracket main body in plate shape, and engaging portions connected to the bracket main body and connected to engaging holes formed in the rear pillar outer member.

The door hinge reinforcement bulkhead may cross the door hinge mounting bracket along the vehicle width direction and may be connected to a mounting surface of the bracket main body between the engaging portions.

The door hinge reinforcement bulkhead may include a bracket connection flange connected to the door hinge mounting bracket, and pillar connection flanges connected to the inner surface of the rear pillar inner member.

The rear pillar outer member, the hinge reinforcement bracket, the door hinge mounting bracket, and the door hinge reinforcement bulkhead may be connected by a 4-layer welding section.

The door hinge mounting bracket may be engaged with the door hinge connected with a twin swing door.

A process of connecting the door hinge reinforcement bulkhead to a predetermined position on the inner surface of the rear pillar inner member, connecting the hinge reinforcement bracket to the inner surface of the rear pillar outer member, and connecting the door hinge mounting bracket to a predetermined position of the hinge reinforcement bracket may be performed.

A process of connecting the rear pillar inner member and the rear pillar outer member may be performed so that the door hinge mounting bracket and the door hinge reinforcement bulkhead are positioned in the same phase.

A process of connecting the rear pillar outer member, the hinge reinforcement bracket, the door hinge mounting bracket, and the door hinge reinforcement bulkhead with 4-layer of welding may be performed.

According to the rear vehicle body structure according to the embodiment, the assembly tolerance of the twin swing door can be absorbed, and the mounting strength of the twin swing door to the rear pillar can be strengthened.

In addition, any effects that can be obtained or expected from the embodiment are disclosed directly or implicitly in the detailed description of the embodiment. That is, various effects expected according to the embodiment will be disclosed in the detailed description that follows.

### BRIEF DESCRIPTION OF THE DRAWINGS

These drawings are intended for reference in describing the embodiments disclosed, and therefore the technical ideas of the embodiments should not be construed as limited to the accompanying drawings.

FIG. 1 is a rear view of a vehicle body illustrating a rear vehicle body structure according to an embodiment.

FIG. 2 is a perspective view illustrating a rear vehicle body structure according to an embodiment.

FIGS. 3, and 4 are exploded perspective views illustrating a rear vehicle body structure according to an embodiment.

FIG. 5 is a cross-sectional view illustrating a rear vehicle body structure according to an embodiment.

FIG. 6 is an exploded perspective view illustrating a connection structure of a hinge reinforcement bracket and a door hinge mounting bracket applied to a rear vehicle body structure according to an embodiment.

FIG. 7 is a perspective view illustrating a hinge reinforcement bracket applied to a rear vehicle body structure according to an embodiment.

FIG. 8 is a perspective view illustrating a door hinge mounting bracket applied to a rear vehicle body structure according to an embodiment.

FIG. 9 is an exploded perspective view illustrating a connection structure of a door hinge reinforcement bulkhead applied to a rear vehicle body structure according to an embodiment.

FIGS. 10A and 10B are perspective views illustrating a door hinge reinforcement bulkhead applied to a rear vehicle body structure according to an embodiment.

FIG. 11 is a perspective view illustrating the connection structure of a door hinge reinforcement bulkhead applied to a rear vehicle body structure according to an embodiment.

The drawings referenced above are not necessarily drawn to scale, but should be understood as presenting simplified representations of various features that illustrate the basic principles of the embodiments. For example, certain design features of the embodiments, including specific dimensions, direction, position, and shape, will be determined in part by the particular intended application and usage environment.

### DETAILED DESCRIPTION OF ILLUSTRATIVE EMBODIMENTS

Embodiment relates to a rear vehicle body structure, and more particularly, to a rear vehicle body structure adapted to mount a twin swing door on a rear pillar.

Hereinafter, with reference to the accompanying drawings, the embodiments are described in detail so that a person of ordinary skill in the technical field to which the embodiment belongs can easily perform the embodiment. However, the embodiments may be implemented in many different forms and are not limited to the embodiments described herein.

As used herein, the singular forms are intended to include the plural forms as well, unless the context clearly indicates otherwise.

It should also be understood that the terms “comprise” and/or “include” as used herein indicate the presence of stated features, integers, steps, operations, elements and/or components, but do not preclude the presence or addition of one or more other features, integers, steps, operations, components, and/or groups thereof. As used herein, the term 'and/or' includes any and all combinations of one or more of the associated listed items.

In this specification, the term ‘connected’ indicates a physical relationship between two components where the components are directly connected to each other by welding, SPR (Self Piercing Rivet), FDS (Flow Drill Screw), structural adhesive, etc., or indirectly connected through one or more intermediate components.

As used herein, 'vehicle', 'vehicular', 'automotive' or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources).

Hereinafter, embodiments of the present disclosure will be described in detail with reference to the attached drawings.

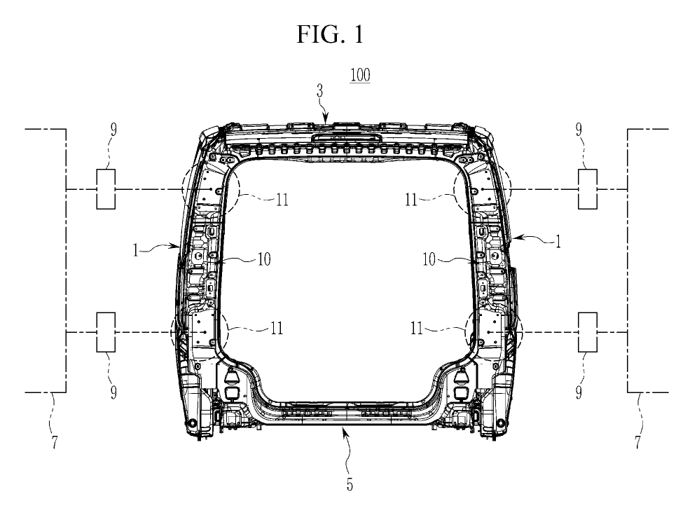

FIG. 1 is a rear view of a vehicle body illustrating a rear vehicle body structure according to an embodiment.

Referring to FIG. 1, a rear vehicle body structure 100 according to the embodiment can be applied, for example, to the vehicle body of a purpose-based mobility vehicle (Purpose Built Vehicle: hereinafter referred to as ‘PBV’).

The PBV may be utilized as an electric vehicle-based life module vehicle that provides various customized services to users during the time they travel from the departure point to the destination.

In one example, the PBV may be manufactured as a one box type design with a wide vehicle interior space. In another example, the PBV may include multiple rows of seats in the vehicle interior space, facing-type seats, or cushion tip up and down seats.

The vehicle body of the PBV may be manufactured in various shapes and sizes depending on the purpose of use of the PBV.

The vehicle body of the PBV may be utilized as a variety of vehicle types, such as a hailing vehicle as a means of transporting occupants, a delivery vehicle for transporting goods, and a special vehicle such as an ambulance.

In this specification, the reference direction for describing the components below may be set as the vehicle body front-back direction (e.g., vehicle body length direction or longitudinal direction), vehicle width direction (e.g., lateral direction or left-right direction), and vertical direction (e.g., height direction) with the vehicle body as reference.

In this specification, the ‘top’, ‘upper’, or ‘upper face’ of a component refers to an end, section, or face of the component that is relatively higher in the drawing, and the ‘bottom’, ‘lower’, or ‘lower face’ of a component refers to an end, section, or face of the component that is relatively lower in the drawing.

In this specification, the term "end" of a component (e.g., one end, the other end, or both ends, etc.) refers to an end of the component in any one direction, and the term "end portion" of a component (e.g., one end portion, the other end portion, both end portions, the front end portion, or the rear end portion, etc.) refers to a portion of the component that includes that end.

The vehicle body of the PBV may include side structures 1 arranged on each side of the vehicle width direction.

The side structure 1 is configured to form a cabin or luggage room of a wide vehicle interior space inside the vehicle body. The side structure 1 may be equipped with a vehicle door, such as a sliding door or swing door.

The rear vehicle body structure 100 according to the embodiment is a rear structure of the side structure 1 and may be connected to the rear of the roof structure 3. The roof structure 3 may include a large area of roof panels. The roof structure 3 may also include a high roof module.

The rear vehicle body structure 100 according to the embodiment may include a rear pillar 10 disposed along a vertical direction on both sides of a vehicle width direction, and a back panel 5 connecting a lower portion of the rear pillar 10 along the vehicle width direction.

The rear pillar 10 is disposed at the rear of the side structure 1, and the upper part of the rear pillar 10 may be connected to the roof structure 3. The rear pillar 10 may be fitted with a rear door, for example a twin swing door 7, to open the cabin or luggage room. The twin swing door 7 may be rotatably mounted on the rear pillar 10 via a door hinge 9.

The door hinge 9 is mounted on predetermined door hinge mounting sections 11 at the upper and lower sides of the rear pillar 10 and may be connected to the twin swing door 7.

The configuration and operation of the twin swing door 7, which may be opened and closed through the door hinge 9, are obvious to those skilled in the art, and thus a detailed description thereof is omitted.

In the rear vehicle body structure 100 according to the embodiment, an assembly deviation of the side structure 1 may occur. An assembly deviation of the side structure 1 may cause an assembly dispersion of the twin swing door 7.

In order to absorb the assembly dispersion of the twin swing door 7, the mounting position of the door hinge 9 can be adjusted to the assembly dispersion tendency of the twin swing door 7 in the door hinge mounting section 11 of the rear pillar 10 when assembling the vehicle body.

The rear vehicle body structure 100 according to the embodiment provides a structure capable of enhancing the mounting strength of the twin swing door 7 to the rear pillar 10 while absorbing the assembly tolerance of the twin swing door 7.

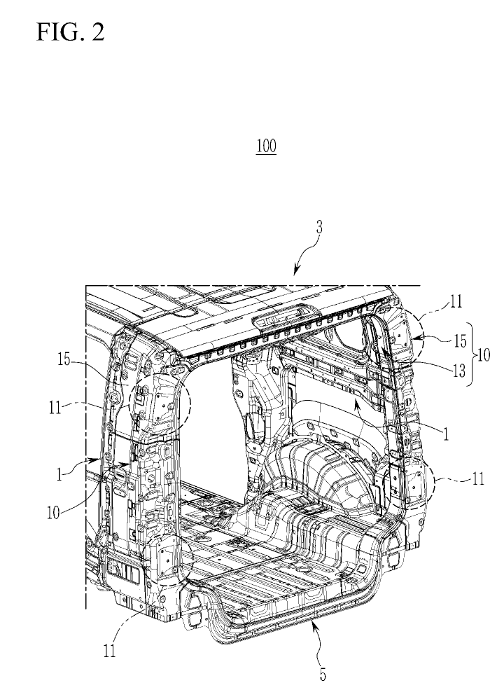

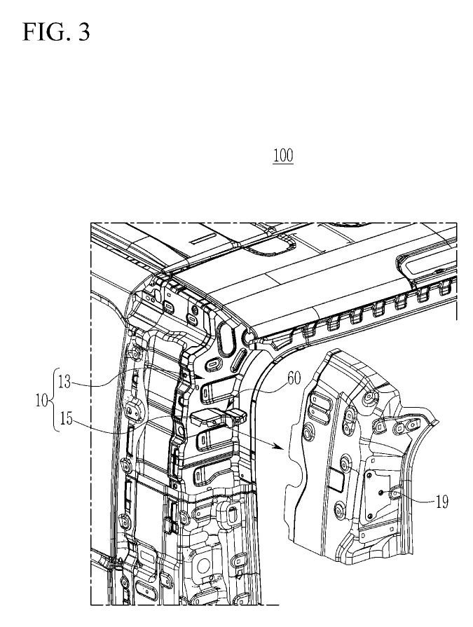

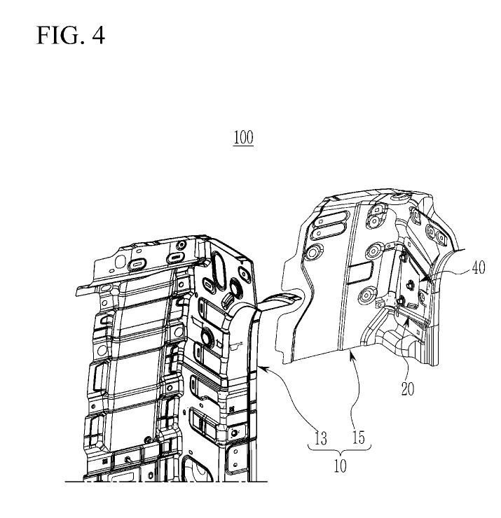

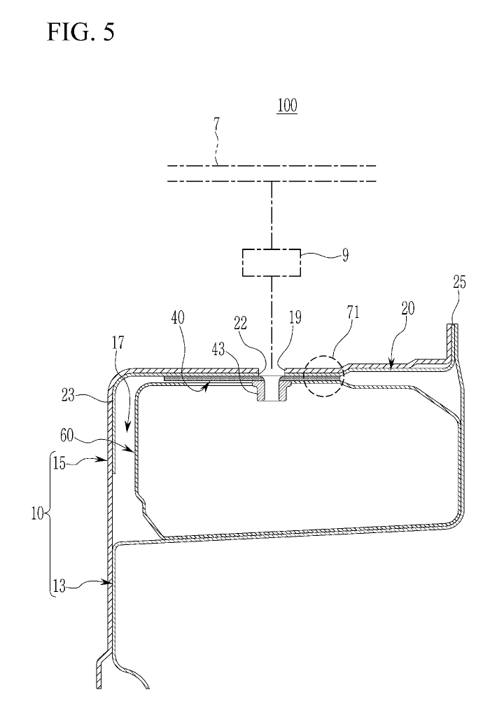

FIG. 2 is a perspective view illustrating a rear vehicle body structure according to an embodiment, and FIGS. 3 and 4 are exploded perspective views illustrating a rear vehicle body structure according to an embodiment. FIG. 5 is a cross-sectional view illustrating a rear vehicle body structure according to an embodiment.

Referring to FIGS. 2-5 , the rear vehicle body structure 100 according to the embodiment may include a hinge reinforcement bracket 20, a door hinge mounting bracket 40, and a door hinge reinforcement bulkhead 60.

The hinge reinforcement bracket 20, door hinge mounting bracket 40 and door hinge reinforcement bulkhead 60 may be mounted on the door hinge mounting section 11 of the rear pillar 10.

The rear pillar 10 may include a rear pillar inner member 13 and a rear pillar outer member 15 that are connected to each other. The rear pillar inner member 13 and the rear pillar outer member 15, which are connected to each other, may form a closed cross-section 17.

The rear pillar inner member 13 may be connected to a rear quarter member provided in the inner part (e.g., side inner assembly) of the side structure 1. The rear pillar outer member 15 may be a rear pillar extension member provided on the outer portion (e.g., side outer assembly) of the side structure 1.

The rear pillar outer member 15 may include a plurality of pillar engaging holes 19 formed at positions corresponding to the door hinge mounting section 11.

In the embodiment, the hinge reinforcement bracket 20 is configured to secure the mounting strength of the door hinge 9 to the rear pillar 10.

The hinge reinforcement bracket 20 may be mounted to the rear pillar outer member 15 within the closed cross-section 17 of the rear pillar 10. The hinge reinforcement bracket 20 may be connected by welding to a predetermined position on the inner surface of the rear pillar outer member 15.

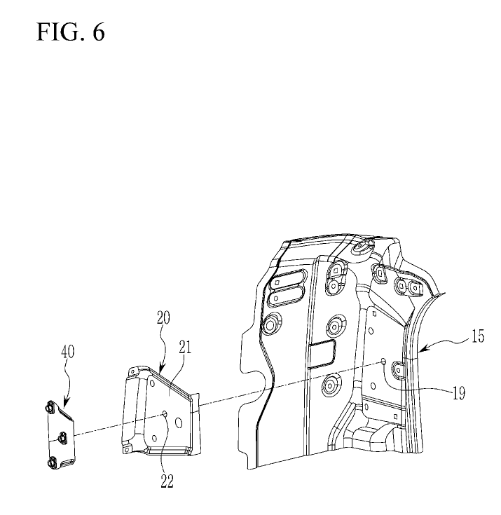

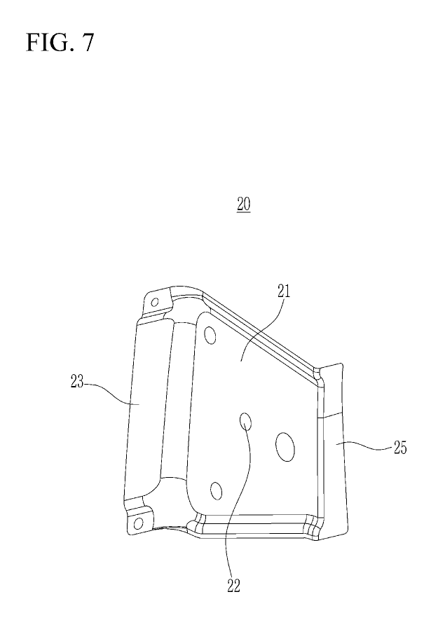

FIG. 6 is an exploded perspective view illustrating a connection structure of a hinge reinforcement bracket and a door hinge mounting bracket applied to a rear vehicle body structure according to an embodiment, and FIG. 7 is a perspective view illustrating a hinge reinforcement bracket applied to a rear vehicle body structure according to an embodiment.

Referring to FIGS. 2-7 , the hinge reinforcement bracket 20 according to the embodiment may be connected by welding to the inner surface of the rear pillar outer member 15 at a position corresponding to the door hinge mounting section 11 of the rear pillar 10.

The hinge reinforcement bracket 20 may include, as shown in FIG. 7, a bracket flat portion 21, a front flange 23, and a rear flange 25.

The bracket flat portion 21 is disposed along the vehicle width direction and may be closely attached to the flat inner surface of the rear pillar outer member 15. The front flange 23 may extend forward from one side of the bracket flat portion 21. The rear flange 25 may extend rearward from the other side of the bracket flat portion 21.

The bracket flat portion 21 may include bracket engaging holes 22 that connect to the pillar engaging holes 19 of the rear pillar outer member 15. The front flange 23 may be connected by welding to the forwardly bent portion of the flat inner surface of the rear pillar outer member 15. The rear flange 25 may be connected by welding to the rear edge of the rear pillar outer member 15.

Referring to FIGS. 2-6 , in the embodiment, the door hinge mounting bracket 40 is configured to mount the door hinge 9 to the outside of the rear pillar 10 via the hinge reinforcement bracket 20.

The door hinge mounting bracket 40 is disposed inside the closed cross-section 17 of the rear pillar 10 and may be connected to the rear pillar outer member 15 via the hinge reinforcement bracket 20.

The door hinge mounting bracket 40 may be mounted on the hinge reinforcement bracket 20. The door hinge mounting bracket 40 may be mounted at a predetermined position of the hinge reinforcement bracket 20.

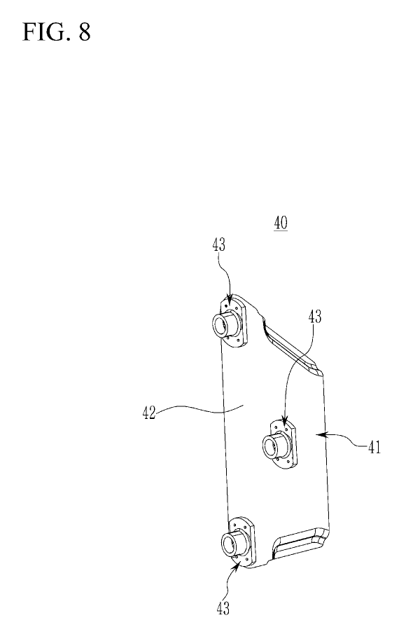

FIG. 8 is a perspective view illustrating a door hinge mounting bracket applied to a rear vehicle body structure according to an embodiment.

As shown in FIGS. 6 and 8 in, the door hinge mounting bracket 40 according to the embodiment may be connected to the hinge reinforcement bracket 20 while making surface contact with the hinge reinforcement bracket 20.

The door hinge mounting bracket 40 may include a bracket main body 41 and a plurality of engaging portions 43.

The bracket main body 41 may be provided in a plate shape. The bracket main body 41 may be connected to the bracket flat portion 21 of the hinge reinforcement bracket 20 by welding while making surface contact with the bracket flat portion 21.

The engaging portions 43 may be connected to the bracket main body 41. The engaging portions 43 may be connected to the bracket engaging holes 22 of the bracket flat portion 21 and the pillar engaging holes 19 of the rear pillar outer member 15.

The engaging portions 43 may include, for example, weld nuts that are projection welded to the bracket main body 41.

The engaging portions 43 of the door hinge mounting bracket 40 may engage the door hinge 9 connected to the twin swing door 7, as shown in FIG. 5.

The door hinge 9 may be engaged to the engaging portions 43 through the pillar engaging holes 19 of the rear pillar outer member 15 and the bracket engaging hole 22 of the bracket flat portion 21 from the outside of the rear pillar 10.

Referring to FIGS. 2-5 , in the embodiment, the door hinge reinforcement bulkhead 60 is configured to reinforce the skeletal strength of the rear pillar 10 and the door hinge mounting strength of the door hinge mounting bracket 40.

The door hinge reinforcement bulkhead 60 may be disposed inside the closed cross-section 17 of the rear pillar 10. The door hinge reinforcement bulkhead 60 may be connected to the inner surface of the rear pillar inner member 13.

The door hinge reinforcement bulkhead 60 may be connected to the door hinge mounting bracket 40 by the rear pillar inner member 13 and the rear pillar outer member 15, which are connected to each other.

The door hinge reinforcement bulkhead 60 is disposed in a position corresponding to the door hinge mounting bracket 40 inside the closed cross-section 17 of the rear pillar 10, and may be connected to the door hinge mounting bracket 40.

The door hinge mounting bracket 40 and the door hinge reinforcement bulkhead 60, which are connected to each other, may be disposed in the door hinge mounting section 11 of the rear pillar 10.

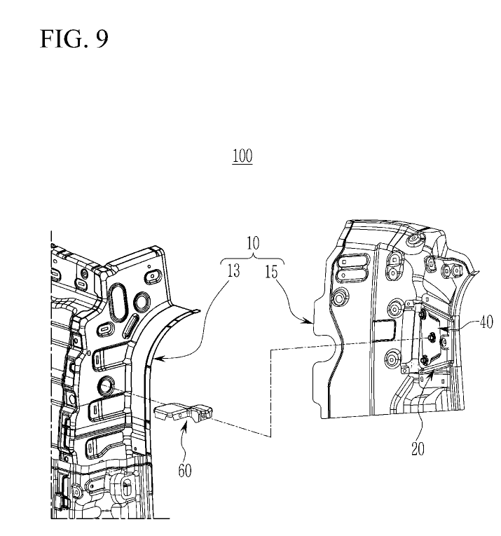

FIG. 9 is an exploded perspective view illustrating a connection structure of a door hinge reinforcement bulkhead applied to a rear vehicle body structure according to an embodiment.

Referring to FIG. 9, the door hinge reinforcement bulkhead 60 according to the embodiment may be connected by welding to a predetermined position on the inner surface of the rear pillar inner member 13.

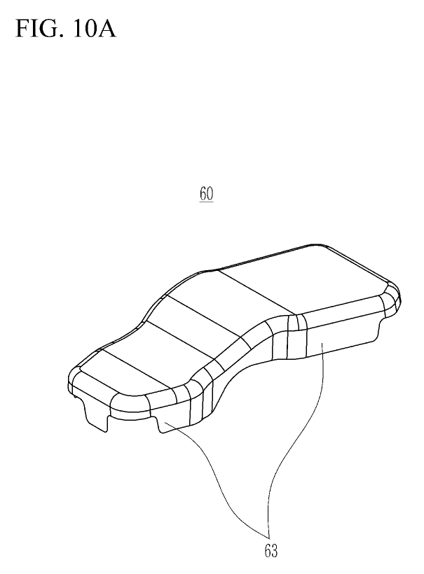

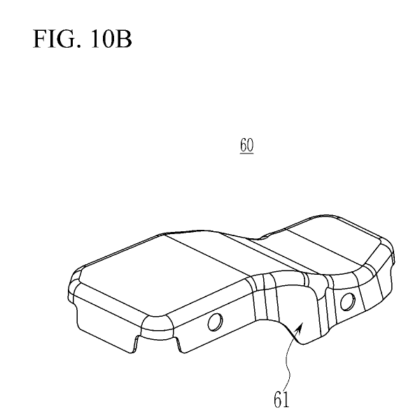

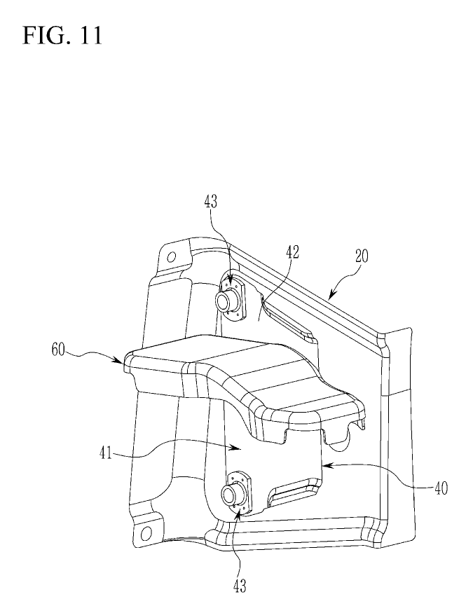

FIGS. 10A and 10B are perspective views illustrating a door hinge reinforcement bulkhead applied to a rear vehicle body structure according to an embodiment, and FIG. 11 is a perspective view illustrating the connection structure of a door hinge reinforcement bulkhead applied to a rear vehicle body structure according to an embodiment.

The door hinge reinforcement bulkhead 60, as shown in FIGS. 10A , 10B and 11 , crosses the door hinge mounting bracket 40 along the vehicle width direction and may be connected to the door hinge mounting bracket 40 by welding.

The door hinge reinforcement bulkhead 60 may include a bracket connection flange 61 and pillar connection flanges 63.

The bracket connection flange 61 may be connected to the door hinge mounting bracket 40 by welding.

The bracket connection flange 61 may be connected by welding to the bracket main body 41 of the door hinge mounting bracket 40. For example, the bracket connection flange 61 may be connected by welding to the mounting surface 42 between the engaging portions 43 in the bracket main body 41.

The pillar connection flanges 63 may be connected by welding to the inner surface of the rear pillar inner member 13.

The rear pillar outer member 15, hinge reinforcement bracket 20, door hinge mounting bracket 40, and door hinge reinforcement bulkhead 60 may be connected by 4-layer welding section 71 (see FIG. 5).

The rear pillar outer member 15, the bracket flat portion 21 of the hinge reinforcement bracket 20, the bracket main body 41 of the door hinge mounting bracket 40, and the bracket connection flange 61 of the door hinge reinforcement bulkhead 60 may be connected by 4-layer welding.

Hereinafter, the assembly process and operation of the rear vehicle body structure 100 according to the embodiment configured as described above will be described in detail referring to FIGS. 1-11 .

In the embodiment, the hinge reinforcement bracket 20, the door hinge mounting bracket 40, and the door hinge reinforcement bulkhead 60 may be provided for mounting the twin swing door 7 to the rear pillar 10 of the vehicle body.

A process of mounting the door hinge reinforcement bulkhead 60 on the inner surface of the rear pillar inner member 13 provided on the inner rear portion of the side structure 1 may be performed.

The door hinge reinforcement bulkhead 60 may be connected to a predetermined position on the inner surface of the rear pillar inner member 13. The pillar connection flanges 63 of the door hinge reinforcement bulkhead 60 may be connected by welding to the inner surface of the rear pillar inner member 13. The predetermined position may be defined as a position corresponding to the door hinge mounting bracket 40, which will be described later.

A process of mounting the hinge reinforcement bracket 20 and the door hinge mounting bracket 40 on the inner surface of the rear pillar outer member 15 provided on the outer rear portion of the side structure 1 may be performed.

In the above process, the hinge reinforcement bracket 20 may be connected to a predetermined position on the inner surface of the rear pillar outer member 15. The pillar engaging holes 19 of the rear pillar outer member 15 and the bracket engaging holes 22 of the hinge reinforcement bracket 20 may be connected to each other. The predetermined position above may be defined as a position where the pillar engaging holes 19 and the bracket engaging holes 22 of the hinge reinforcement bracket 20 are connected.

The bracket flat portion 21 of the hinge reinforcement bracket 20 may be in close contact with the flat inner surface of the rear pillar outer member 15. The front flange 23 and rear flange 25 of the hinge reinforcement bracket 20 may be connected to the rear pillar outer member 15 by welding.

The door hinge mounting bracket 40 may be connected to a predetermined position of the hinge reinforcement bracket 20. Here, the predetermined position may be defined as a position adjusted to the assembly dispersion tendency of the twin swing door 7 in the hinge reinforcement bracket 20.

The bracket main body 41 of the door hinge mounting bracket 40 may be connected to the bracket flat portion 21 of the hinge reinforcement bracket 20 by welding while making surface contact with the bracket flat portion 21. The engaging portions 43 of the door hinge mounting bracket 40 may be connected to the bracket engaging holes 22 of the bracket flat portion 21 and the pillar engaging holes 19 of the rear pillar outer member 15.

A process may be performed to connect the rear pillar inner member 13, on which the door hinge reinforcement bulkhead 60 is mounted, and the rear pillar outer member 15, on which the hinge reinforcement bracket 20 and the door hinge mounting bracket 40 are mounted.

In the above process, the rear pillar outer member 15 is loaded onto the rear pillar inner member 13 along the vehicle width direction.

The door hinge reinforcement bulkhead 60 may be connected to the door hinge mounting bracket 40 by the rear pillar inner member 13 and the rear pillar outer member 15.

The bracket connection flange 61 of the door hinge reinforcement bulkhead 60 may be closely attached to the bracket main body 41 of the door hinge mounting bracket 40. The door hinge reinforcement bulkhead 60 may be disposed in the same phase as the door hinge mounting bracket 40.

The same phase may be defined as a position where the door hinge reinforcement bulkhead 60 and the door hinge mounting bracket 40 are mounted at a position corresponding to the door hinge 9 and support the door hinge 9 together.

The rear pillar inner member 13 and the rear pillar outer member 15 may be connected by welding.

The rear pillar inner member 13 and the rear pillar outer member 15, which are connected to each other, may be configured as the rear pillar 10 having the closed cross-section 17.

The hinge reinforcement bracket 20, the door hinge mounting bracket 40 and the door hinge reinforcement bulkhead 60, which are connected to each other, may be disposed inside the closed cross-section 17 of the rear pillar 10 in the door hinge mounting section 11 of the rear pillar 10.

The rear pillar outer member 15, the bracket flat portion 21 of the hinge reinforcement bracket 20, the bracket main body 41 of the door hinge mounting bracket 40, and the bracket connection flange 61 of the door hinge reinforcement bulkhead 60 may be connected by 4-layer welding.

After going through a series of processes as described above, the door hinge 9 may be mounted on the door hinge mounting section 11 of the rear pillar 10 from the outside of the rear pillar 10.

The door hinge 9 may be mounted to the door hinge mounting bracket 40 by a fastening member (not shown) including, for example, a combination of a bolt and a nut.

The bolt may pass through the door hinge 9, the pillar engaging holes 19 of the rear pillar outer member 15, and the bracket engaging hole 22 of the hinge reinforcement bracket 20 to engage the engaging portions 43 of the door hinge mounting bracket 40.

With the door hinge 9 connected to the door hinge mounting section 11 of the rear pillar 10, the twin swing door 7 may be rotatably mounted on the door hinge 9.

According to the rear vehicle body structure 100 according to the embodiment, the door hinge mounting bracket 40 may be connected to the rear pillar outer member 15 via the hinge reinforcement bracket 20 with the position adjusted to match the assembly dispersion tendency of the twin swing door 7.

According to the rear vehicle body structure 100 according to the embodiment, the door hinge reinforcement bulkhead 60 may be connected to the rear pillar inner member 13, and the rear pillar outer member 15 may be connected to the rear pillar inner member 13.

According to the rear vehicle body structure 100 according to the embodiment, the door hinge mounting bracket 40 and the door hinge reinforcement bulkhead 60 are disposed in the same phase and may be connected to each other.

Accordingly, according to the rear vehicle body structure 100 according to the embodiment, the mounting position of the door hinge 9 mounted on the door hinge mounting bracket 40 may be adjusted to suit the assembly dispersion tendency of the twin swing door 7. That is, the door hinge mounting bracket 40 may be mounted in a position that may absorb the assembly tolerance of the twin swing door 7.

Accordingly, according to the rear vehicle body structure 100 according to the embodiment, the assembly tolerance of the twin swing door 7 due to the assembly deviation of the side structure 1 may be absorbed, thereby minimizing the gap step of the twin swing door 7.

According to the rear vehicle body structure 100 according to the embodiment, the door hinge mounting bracket 40 and the door hinge reinforcement bulkhead 60 may be connected to each other, so that the mounting strength of the twin swing door 7 to the rear pillar 10 may be strengthened.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A vehicle body structure comprising:
a rear pillar configured to be arranged at a side of a rear of a vehicle body, wherein the rear pillar comprises a rear pillar inner member and a rear pillar outer member connectable to the rear pillar inner member to provide a closed cross-section between the rear pillar inner member and the rear pillar outer member;
a door hinge mounting bracket configured to be arranged within the closed cross-section of the rear pillar and connectable to the rear pillar outer member; and
a door hinge reinforcement bulkhead configured to be arranged inside the closed cross-section of the rear pillar and connectable to the rear pillar inner member and the door hinge mounting bracket.

2. The vehicle body structure of claim 1, further comprising a hinge reinforcement bracket connectable to the rear pillar outer member, wherein the door hinge mounting bracket is mountable to the hinge reinforcement bracket.

3. The vehicle body structure of claim 2, wherein the door hinge reinforcement bulkhead comprises:
a bracket connection flange connectable to the door hinge mounting bracket; and
pillar connection flanges connectable to an inner surface of the rear pillar inner member.

4. The vehicle body structure of claim 2, wherein the rear pillar outer member, the hinge reinforcement bracket, the door hinge mounting bracket, and the door hinge reinforcement bulkhead are connectable by 4-layer welding.

5. The vehicle body structure of claim 1, wherein the door hinge reinforcement bulkhead and the door hinge mounting bracket are configured to be mounted together to support a door hinge.

6. The vehicle body structure of claim 1, wherein the door hinge mounting bracket and the door hinge reinforcement bulkhead are configured to be arranged at predetermined door hinge mounting sections at upper and lower portions of the rear pillar.

7. The vehicle body structure of claim 1, wherein the door hinge mounting bracket is mountable at a predetermined position on the rear pillar outer member, wherein the door hinge reinforcement bulkhead is mountable at a predetermined position on the rear pillar inner member, and wherein the door hinge mounting bracket and the door hinge reinforcement bulkhead are connectable by the rear pillar inner member and the rear pillar outer member.

8. The vehicle body structure of claim 1, wherein the door hinge mounting bracket comprises:
a bracket main body having a plate shape; and
engaging portions connectable to the bracket main body and connectable to engaging holes in the rear pillar outer member.

9. The vehicle body structure of claim 8, wherein the door hinge reinforcement bulkhead is configured to cross the door hinge mounting bracket along a width direction of the vehicle body and is connectable to a mounting surface of the bracket main body between the engaging portions.

10. The vehicle body structure of claim 1, wherein the door hinge mounting bracket is engageable with a door hinge connected to a door.

11. A method of assembling a vehicle body structure comprising:
connecting a door hinge reinforcement bulkhead to a predetermined position on an inner surface of a rear pillar inner member;
connecting a hinge reinforcement bracket to an inner surface of a rear pillar outer member; and
connecting a door hinge mounting bracket to a predetermined position of the hinge reinforcement bracket.

12. The method of claim 11, further comprising:
connecting the rear pillar inner member and the rear pillar outer member so that the door hinge mounting bracket and the door hinge reinforcement bulkhead are mounted together to support a door hinge.

13. The method of claim 12, further comprising:
connecting the rear pillar outer member, the hinge reinforcement bracket, the door hinge mounting bracket, and the door hinge reinforcement bulkhead by 4-layer welding.

14. A vehicle body structure comprising:
a rear pillar disposed at a side of a rear of a vehicle body, wherein the rear pillar comprises a rear pillar inner member and a rear pillar outer member connected to the rear pillar inner member to provide a closed cross-section between the rear pillar inner member and the rear pillar outer member;
a door hinge mounting bracket disposed within the closed cross-section of the rear pillar and connected to the rear pillar outer member;
a door hinge reinforcement bulkhead disposed inside the closed cross-section of the rear pillar and connected to the rear pillar inner member and the door hinge mounting bracket; and
a hinge reinforcement bracket connected to the rear pillar outer member.

15. The vehicle body structure of claim 14, wherein the door hinge mounting bracket is mounted to the hinge reinforcement bracket, and wherein the rear pillar outer member, the hinge reinforcement bracket, the door hinge mounting bracket, and the door hinge reinforcement bulkhead are connected by 4-layer welding.

16. The vehicle body structure of claim 14, wherein the door hinge mounting bracket is mounted at a predetermined position on the rear pillar outer member, wherein the door hinge reinforcement bulkhead is mounted at a predetermined position on the rear pillar inner member, and wherein the door hinge mounting bracket and the door hinge reinforcement bulkhead are connected by the rear pillar inner member and the rear pillar outer member.

17. The vehicle body structure of claim 14, wherein the door hinge mounting bracket comprises:
a bracket main body having a plate shape; and
engaging portions connected to the bracket main body and connected to engaging holes in the rear pillar outer member.

18. The vehicle body structure of claim 17, wherein the door hinge reinforcement bulkhead crosses the door hinge mounting bracket along a width direction of the vehicle body and is connected to a mounting surface of the bracket main body between the engaging portions.

19. The vehicle body structure of claim 14, wherein the door hinge reinforcement bulkhead comprises:
a bracket connection flange connected to the door hinge mounting bracket; and
pillar connection flanges connected to an inner surface of the rear pillar inner member.

20. The vehicle body structure of claim 14, wherein the door hinge mounting bracket is engageable with a door hinge connected to a door.
